(19) United States
(12) Patent Application Publication
(10) Pub. No.: US 2020/0202851 A1
(43) Pub. Date: Jun. 25, 2020

(54) SPEECH RECOGNITION DEVICE AND SYSTEM

(71) Applicant: SHENZHEN LENKENG TECHNOLOGY CO., LTD., Shenzhen City (CN)

(72) Inventor: BINGHAI GAO, Shenzhen City (CN)

(21) Appl. No.: 16/427,335

(22) Filed: May 30, 2019

(30) Foreign Application Priority Data
Dec. 20, 2018 (CN) 201822144428.X

(51) Int. Cl. G10L 15/22; G10L 15/20; G10L 21/0232; G10L 25/84; H04R 1/40; H04N 5/33; G06F 13/40; G06F 13/42; G06N 3/02

(52) U.S. Cl. CPC G10L 15/22; G10L 15/20; G10L 21/0232; G10L 25/84; H04R 1/406; G06F 2213/0004; G06F 13/40; G06F 13/4204; G06N 3/02; G10L 2015/223; H04N 5/33

(57) ABSTRACT

A speech recognition device includes a voice collection module configured to collect voices; a voice denoising module electrically connected to the voice collection module and configured to denoise the collected voice; a voice recognition module electrically connected to the voice denoising module and configured to recognize voices denoised by the voice denoising module and converted the denoised voices into control instructions; an interface conversion module electrically connected to the voice recognition module and configured to convert the control instructions into digital signals; and a parallel port interface electrically connected to the interface conversion module and configured to be inserted into an electronic device so that the digital signals can be transmitted to the electronic device via the parallel port interface. The present invention provides a new speech recognition device and system to fast response to simple operation instructions without cloud recognition operation.

### TECHNICAL FIELD

The present invention relates to the field of speech recognition, in particular to a speech recognition device and system.

### BACKGROUND

A traditional speech recognition device generally performs a speech recognition processing function by a cloud server when it receives a speech instruction. However, the cloud sever is communicated with the traditional speech recognition device via a network, the response time of the speech instruction is limited by the scene, such as the network is unstable. And it is not conducive to the quick response of simple operation instructions.

### SUMMARY

In order to overcome the deficiencies of the prior art, one of the objects of the present invention is to provide a speech recognition device for quickly responding to simple operation instructions.

A second object of the present invention is to provide a speech recognition system for quickly responding to simple operation instructions.

One of the objects of the present invention is achieved by the following technical solutions:

A speech recognition device, electrically and detachably coupled to the electric device, comprising: a voice collection module, a voice denoising module electrically connected to the voice collection module, a voice recognition module electrically connected to the voice denoising module, and an interface conversion module electrically connected to the voice recognition module and a parallel port interface electrically connected to the interface conversion module; the voice collection module is configured to collect voice, and the voice denoising module is configured to process the collected voice, the voice recognition module is configured to identify the voice processed by the noise reduction and converted into a control instruction, the interface conversion module is configured to convert the control instruction into a digital signal, and the parallel port interface and the electronic device are inserted, the digital signal is sent to the electronic device through the parallel port interface.

Further, the parallel port interface is an 8 pin header interface for transmitting a binary control signal.

Further, one of the pins of the parallel port interface electrically connects a power source of the electronic device to supply power to the speech recognition device.

Further, the voice collection module comprises a single microphone, a dual microphone or microphone matrix.

Further, the speech recognition device further comprising a voice prompting module electrically connected to the voice recognition module, wherein the voice prompting module is configured to issue a prompt voice when the voice recognition module succeeds in voice recognition.

Further, the speech recognition device further comprising a display module electrically connected to the speech recognition module, wherein the display module is configured to display an operation state of the speech recognition module, and display when the speech recognition is successful prompt message.

Further, the speech recognition device further comprising a setting button electrically connected to the voice recognition module, the setting button is used to switch the voice recognition type of the voice recognition module, the type of the voice recognition module comprising voiceprint recognition and neural network.

Further, the speech recognition device further comprising an infrared detecting module electrically connected to the voice collection module, wherein the infrared detecting module is configured to control the voice collection module to turn on when the human body is detect.

The second object of the present invention is achieved by the following technical solutions:

A speech recognition system, comprising:

an electronic device, comprising an insertion interface; and

a speech recognition device, electrically and detachably coupled to the electric device, comprising:

a voice collection module configured to collect voices;

a voice denoising module electrically connected to the voice collection module and configured to denoise the collected voice;

a voice recognition module electrically connected to the voice denoising module and configured to recognize voices denoised by the voice denoising module and converted the denoised voices into control instruction;

an interface conversion module electrically connected to the voice recognition module and configured to convert the control instructions into digital signals; and

a parallel port interface electrically connected to the interface conversion module and configured to be inserted into the insertion interface, the digital signals can be transmitted to the electronic device via the parallel port interface.

The electronic device is a smart speaker.

Further, the parallel port interface is an 8 pin header interface for transmitting a binary control signal.

Further, one of the pins of the parallel port interface electrically connects a power source of the electronic device to supply power to the speech recognition device.

Further, the voice collection module comprises a single microphone, a dual microphone or microphone matrix.

Further, the speech recognition device further comprising a voice prompting module electrically connected to the voice recognition module, wherein the voice prompting module is configured to issue a prompt voice when the voice recognition module succeeds in voice recognition.

Further, the speech recognition device further comprising a display module electrically connected to the speech recognition module, wherein the display module is configured to display an operation state of the speech recognition module, and display when the speech recognition is successful prompt message.

Further, the speech recognition device further comprising a setting button electrically connected to the voice recognition module, the setting button is used to switch the voice recognition type of the voice recognition module.

Further, the speech recognition device further comprising an infrared detecting module electrically connected to the voice collection module, wherein the infrared detecting module is configured to control the voice collection module to turn on when a human body is detect.

Further, the electronic device is a smart speaker.

Compared with the prior art, the present invention has the beneficial effects that the voice collection module collects voice, the voice denoising module performs noise reduction on the collected voice, and the voice recognition module recognizes the voice that has been subjected to denoising and converts into a control instruction, the interface conversion module converts the control instruction into a digital signal and sends it to the electronic device through the parallel port pin, thereby eliminating the need for cloud recognition operation and quickly responding to simple operation instructions.

### BRIEF DESCRIPTION OF THE DRAWINGS

FIG. 1 is a schematic diagram of a speech recognition device according to an embodiment;

FIG. 2 is a schematic diagram of a speech recognition system according to an embodiment.

### DETAILED DESCRIPTION OF THE EMBODIMENTS

In the following, the present invention will be further described in conjunction with the accompanying drawings and specific embodiments. It should be noted that, under the premise of non-conflict, the embodiments described below or the technical features can be combined together to form a new embodiment.

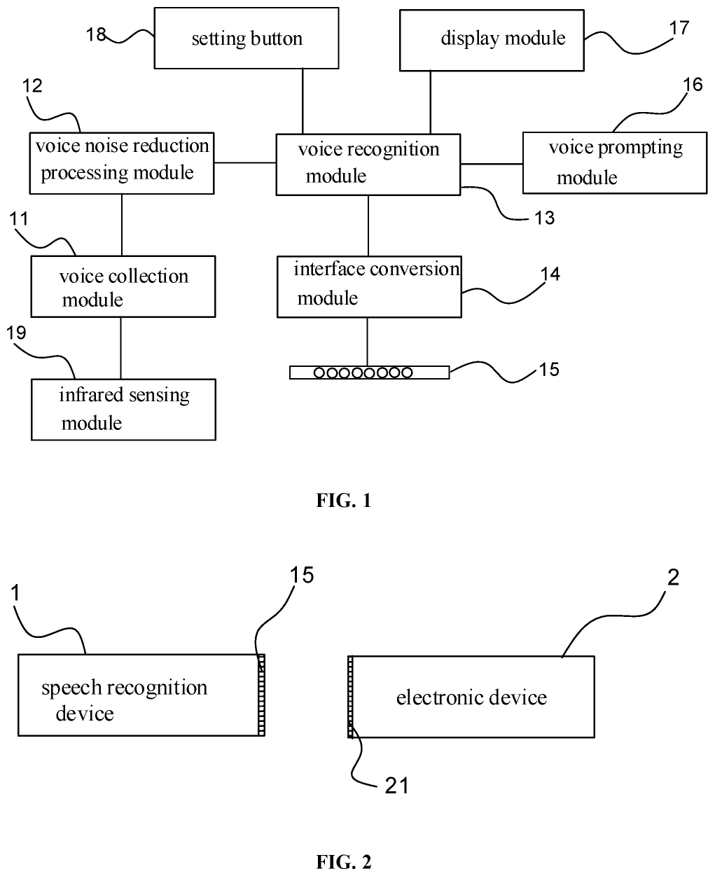

As shown in FIG. 1, a speech recognition device 1 according to an embodiment includes a voice collection module 11, a voice denoising module 12 electrically connected to the voice collection module 11, a voice recognition module 13 electrically connected to the voice denoising module 12, an interface conversion module 14 electrically connected to the voice recognition module 13 and a parallel port interface 15 electrically connected to the interface conversion module 14. The voice collection module 11 is configured to collect voice. The voice denoising module 12 is configured to process the collected voice to remove noises of the collectied voice. The voice recognition module 13 is configured to recognize the processed voice output by the denoising module 12 and convert the processed voice into a control instruction. The interface conversion module 14 is configured to convert the control instruction into a digital signal. The parallel port interface 15 is inserted to an electronic device 2 to electrically couple to the electronic device 2, and the digital signal is sent to the electronic device 2 through the parallel port pin header interface 15. Thus, a quick response to a simple command can be realized without networking to a server. In some embodiments, each of the voice recognition module 13 and the interface conversion module 14 may be an integrated circuit, a microchip, or a chip which can perform the corresponding function. In some other embodiments, the voice recognition module 13 and the interface conversion module 14 are integrated in one integrated circuit, one microchip, or one chip which can perform the corresponding function.

As a preferred embodiment, the voice collection module 11 includes a single microphone, a dual microphone or microphone matrix, and the parallel port interface 15 is an 8 pin header interface for transmitting binary control signals. One of the pins of the parallel port interface 15 is electrically connected to the electronic device 2 for receiving the power from the electronic device 2 to supply the power to the speech recognition device 1, so that there is no need to provide another power source to power up the speech recognition device 1.

As a preferred embodiment, the speech recognition device 1 further includes a voice prompting module 16 electrically connected to the voice recognition module 13. The voice prompting module 16 is configured to output a prompt voice when the voice recognition module 13 successfully recognizes the voice. The speech recognition device 1 further includes a display module 17 electrically connected to the voice recognition module 13, and the display module 17 is configured to display a working state of the voice recognition module 13, and display prompt information when the voice is successfully recognized. The speech recognition device 1 further includes a setting button 18 electrically connected to the voice recognition module 13, and the setting button 18 is used to enable the voice recognition module 13 to select a corresponding voice recognition type for recognizing a desired speech such as Chinese, English and the like. For example, the speech recognition device 1 has a database for storing a plurality types of speech, such as Chinese, Mandarin, dialect, English, and the like. The voice recognition module 13 selects different recognition types according to the setting button 18, the type of the voice recognition module comprising voiceprint recognition and neural network, and correspondingly recognizes voices through different databases.

As a preferred embodiment, the speech recognition device 1 further includes an infrared detecting module 19 electrically connected to the voice collection module 11. The infrared detecting module 19 is configured to control the voice collection module 11 to be activated when the human body is detect, so as to recognize the voice in real time while reducing the power consumption of the speech recognition device.

As shown in FIG. 2, the voice recognition system according to an embodiment includes an electronic device 2 and the speech recognition device 1 described above. The electronic device 2 is provided with an insertion interface 21 suit for the parallel port interface 15. The electronic device 2 a smart speaker. The speech recognition device 1 is electrically coupled to the electronic device 2 and fastened to the electronic device 2 when the parallel port interface 15 and the insertion interface 21 are coupled together. The speech recognition device 1 is removed from the electronic device 2 when thee parallel port interface 15 and the insertion interface 21 are separated from each other. The speech recognition device 1 further collects the voice, and recognizes the voice and generates the corresponding control instruction when the voice is recognized. And the control instruction is transmitted to the electronic device 2 to control the electronic device 2 perform a corresponding function.

As described above, the speech recognition device is electrically and detachably coupled to the electric device, the voice collection module 11 collects the voice, the voice denoising module 12 performs noise reduction on the collected voice, and the voice recognition module 13 recognizes the voice that has been subjected to denoising and converts into a control instruction, the interface conversion module 14 converts the control instruction into a digital signal, and sends it to the electronic device 2 through the parallel port pin 15, thereby eliminating the need for cloud recognition operations and quickly responding to simple operation instructions.

The above embodiments are merely preferred embodiments of the present invention, and the scope of protection of the present invention is not limited thereto, and any insubstantial changes and substitutions made by those skilled in the art based on the present invention belong to the scope of the claimed invention.

What is claimed is:

1. A speech recognition device, electrically and detachably coupled to the electric device, comprising:
a voice collection module configured to collect voices;
a voice denoising module electrically connected to the voice collection module and configured to process the collected voice to reduce noises of the collected voice;
a voice recognition module electrically connected to the voice denoising module and configured to recognize the processed voice output by the denoising module and converted the processed voices into control instruction;
an interface conversion module electrically connected to the voice recognition module and configured to convert the control instructions into digital signals; and
a parallel port interface electrically connected to the interface conversion module and configured to be inserted into an electronic device so that the digital signals can be transmitted to the electronic device via the parallel port interface.

2. The speech recognition device of claim 1, wherein the parallel port interface is an 8-pin parallel port interface for transmitting a binary control signal.

3. The speech recognition device of claim 2, wherein one of the pins of the parallel port interface is configured to electrically connect with a power source of the electronic device to supply power to the speech recognition device.

4. The speech recognition device of claim 1, wherein said the voice collection module comprises a single microphone, a dual microphone or microphone matrix.

5. The speech recognition device of claim 1, further comprising a voice prompting module electrically connected to the voice recognition module, wherein the voice prompting module is configured to output a prompt voice when the voice recognition module succeeds in voice recognition.

6. The speech recognition device of claim 5, further comprising a display module electrically connected to the speech recognition module, wherein the display module is configured to display an operation state of the speech recognition module, and display prompt a message when speech recognition is succeeded.

7. The speech recognition device of claim 1, further comprising a setting button electrically connected to the voice recognition module, wherein the setting button is configured to switch voice recognition types of the voice recognition module, the type of the voice recognition module comprising voiceprint recognition and neural network.

8. The speech recognition device of claim 1, further comprising an infrared detecting module electrically connected to the voice collection module, wherein the infrared detecting module is configured to control the voice collection module to turn on when a human body is detected.

9. A speech recognition system, comprising:
an electronic device, comprising an insertion interface; and
a speech recognition device, electrically and detachably coupled to the electric device, comprising:
a voice collection module configured to collect voices;
a voice denoising module electrically connected to the voice collection module and configured to denoise the collected voice;
a voice recognition module electrically connected to the voice denoising module and configured to recognize voices denoised by the voice denoising module and converted the denoised voices into control instruction;
an interface conversion module electrically connected to the voice recognition module and configured to convert the control instructions into digital signals; and
a parallel port interface electrically connected to the interface conversion module and configured to be inserted into the insertion interface, the digital signals can be transmitted to the electronic device via the parallel port interface.

10. The speech recognition system of claim 9, wherein the electronic device is a smart speaker.

11. The speech recognition system of claim 9, wherein the parallel port interface is an 8-pin parallel port interface for transmitting a binary control signal.

12. The speech recognition system of claim 11, wherein one of the pins of the parallel port interface is configured to electrically connect with a power source of the electronic device to supply power to the speech recognition device.

13. The speech recognition system of claim 9, wherein the voice collection module comprises a single microphone, a dual microphone or microphone matrix.

14. The speech recognition system of claim 9, further comprising a voice prompting module electrically connected to the voice recognition module, wherein the voice prompting module is configured to output a prompt voice when the voice recognition module succeeds in voice recognition.

15. The speech recognition system of claim 14, further comprising a display module electrically connected to the speech recognition module, wherein the display module is configured to display an operation state of the speech recognition module, and display a prompt message when speech recognition is succeeded.

16. The speech recognition system of claim 9, further comprising a setting button electrically connected to the voice recognition module, wherein the setting button is configured to switch voice recognition types of the voice recognition module.

17. The speech recognition system of claim 9, further comprising an infrared detecting module electrically connected to the voice collection module, wherein the infrared detecting module is configured to control the voice collection module to turn on when a human body is detected.
